(19) United States
(12) Patent Application Publication
(10) Pub. No.: US 2018/0234753 A1
(43) Pub. Date: Aug. 16, 2018

(54) EARPIECE STRUCTURE

(71) Applicant: TECHWIN COMMUNICATIONS CO., LTD., Taoyuan City (TW)

(72) Inventor: CHUNG-HSIEN CHEN, Taoyuan City (TW)

(21) Appl. No.: 15/430,547

(22) Filed: Feb. 13, 2017

(51) Int. Cl. H04R 1/10

(52) U.S. Cl. CPC H04R 1/1008; H04R 1/023; H04R 1/1075

(57) ABSTRACT

The earpiece structure includes a main member having a sound releasing element on an inner side, a fixation element besides the sound releasing element slant toward an outer side of the main member, and an extension element between the sound releasing element and the fixation element. A number of through opening are configured on the extension element, each configured with a tuning element. A speaker element is disposed on the fixation element. Due to the slant arrangement of the fixation element, the sound wave from the speaker element progresses directly towards a user's eardrum through the ear canal. The tuning elements achieve an optimal proportion between air pressures of front and rear chambers of the earpiece structure, allowing the sound wave to reverberate and reflect in a sound space and achieving superior sound field.

### BACKGROUND OF THE INVENTION

### (a) Technical Field of the Invention

The present invention is generally related to earphones and more particular to an earpiece structure for earphones.

### (b) Description of the Prior Art

When a user's ear canal is aligned with the direction of the sound wave produced from an earphone, the ear is able to perceive the sound wave of the greatest magnitude. But if the ear canal and the sound wave are not aligned, an inferior sound effect is achieved. In addition, conventional earphones do not provide appropriate isolation between a front chamber and a rear chamber, allowing air pressure from the front chamber to propagate to the rear chamber and therefore compromising the sound quality, leading to inferior fidelity and sound field.

### SUMMARY OF THE INVENTION

A major objective of the present invention is, therefore, to provide a slant design of a speaker element so that the sound wave may directly reach the eardrum, thereby enhancing the sound quality.

Another major objective of the present invention is to provide a tuning element (e.g., tuning paper) to achieve an optimal proportion between the air pressures of the front and rear chambers, allowing the sound wave to reverberate and reflect in a sound space and thereby achieving superior sound field.

To achieve the objectives, the earpiece structure includes a main member having a sound releasing element on an inner side, a fixation element besides the sound releasing element slant toward an outer side of the main member, and an extension element between the sound releasing element and the fixation element. A number of through opening are configured on the extension element, each configured with and covered by a tuning element. A speaker element is disposed on the fixation element. A sound space is formed between the sound releasing element and the fixation element. Due to the slant arrangement of the fixation element, the sound wave from the speaker element progresses directly towards a user's eardrum through the ear canal, thereby enhancing sound quality. The tuning elements achieve an optimal proportion between air pressures of front and rear chambers of the earpiece structure, allowing the sound wave to reverberate and reflect in the sound space and achieving superior sound field.

The present invention successfully resolves the prior art's problem such as the inappropriate isolation between the front and rear chambers, the escape of air pressure from the front chamber to the rear chamber, the compromise of the sound quality, and inferior fidelity and sound field.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an earpiece according to an embodiment of the present invention configured on a headset.

FIG. 2 is a perspective break-down diagram showing the earpiece of FIG. 1.

FIG. 3 is a schematic sectional diagram showing the earpiece of FIG. 1.

FIG. 4 is a schematic diagram showing an application scenario of the eyepiece of FIG.1.

FIG. 5 is a schematic sectional diagram showing progress of sound waves within the earpiece of FIG. 1.

FIG. 6 is a front-view diagram showing an earpiece according to another embodiment of the present invention.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

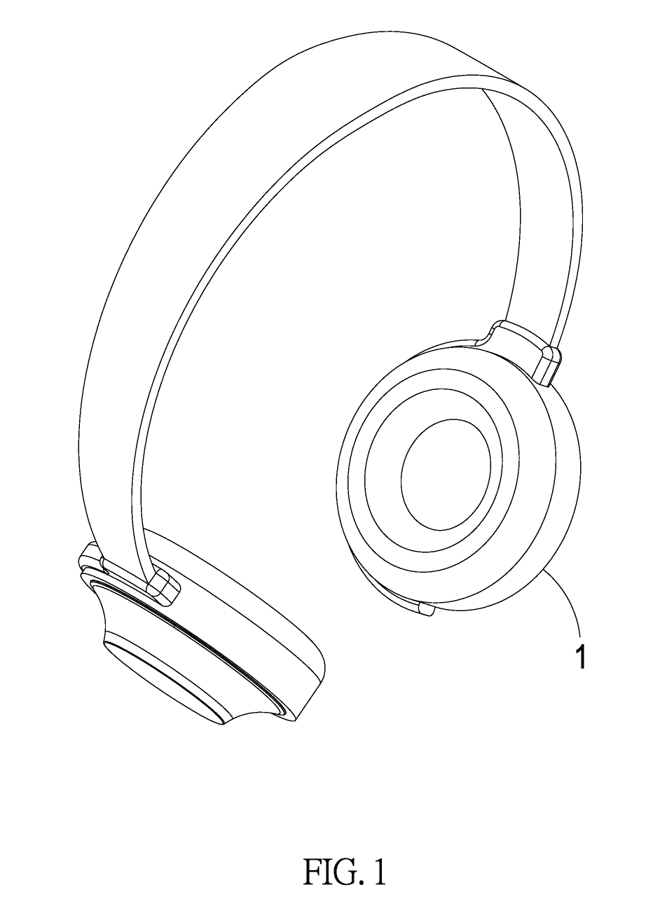

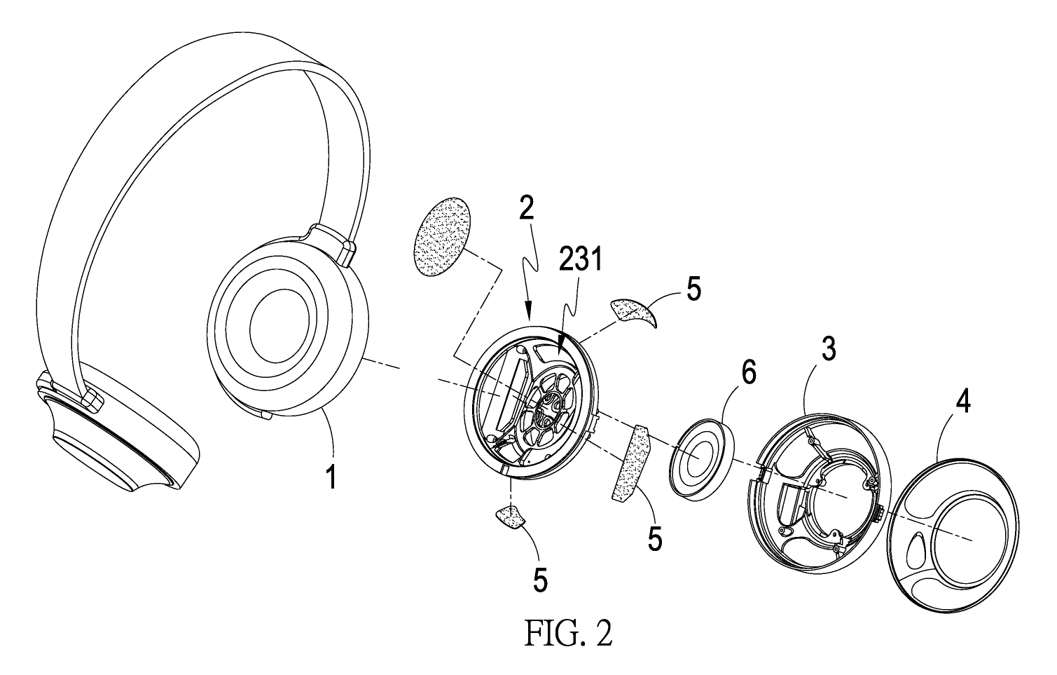

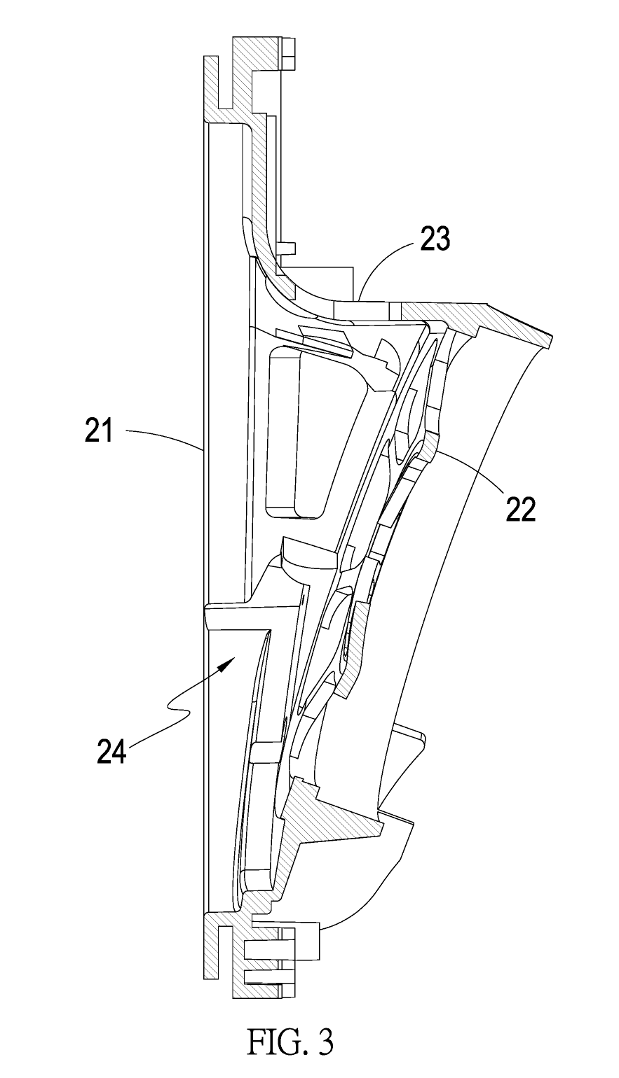

Please refer to FIGS. 1 to 3, which are perspective, break-down, and sectional diagrams of an earpiece according to an embodiment of the present invention. As illustrated, the earpiece includes the following components.

There is an inner muff member 1.

There is a main member 2 housed in the inner muff member 1. The main member 2 includes a sound releasing element 21 on an inner side, a fixation element 22 besides the sound releasing element 21 slant toward an outer side of the main member 2, an extension element 23 between the sound releasing element 21 and the fixation element 22. A sound space 24 is formed between the sound releasing element 21 and the fixation element 22.

There is a rear cap 3 joined to an outer side of the main member 2. In turn, an external muff member 4 is joined to an outer side of the rear cap 3.

A number of through opening 231 are configured on the extension element 23.

Each opening 231 is configured with a corresponding tuning element 5. In the present embodiment, each tuning element 5 is a tuning paper.

A speaker element 6 is disposed on the fixation element 22.

The included angle between the sound releasing element 21 and the fixation element 22 is between 16 and 24 degrees, preferably 20 degree.

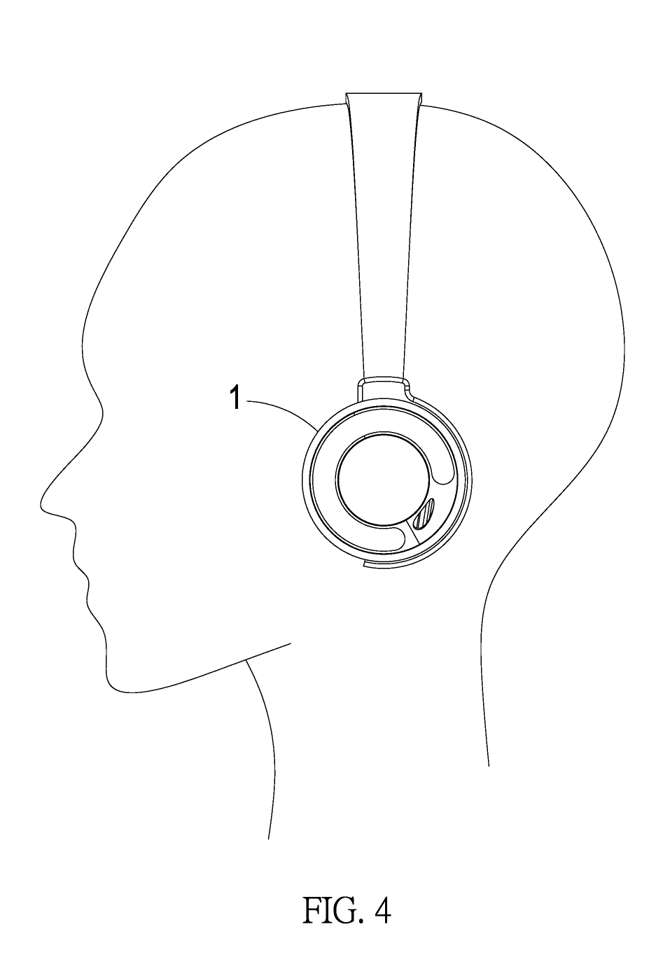

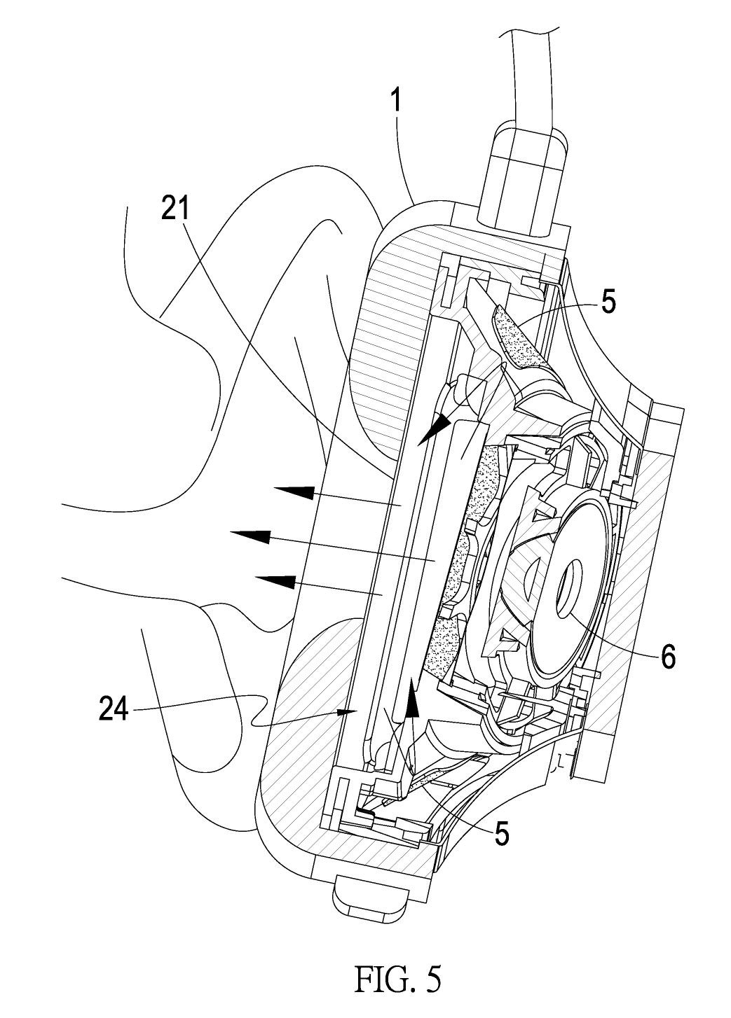

As further shown in FIGS. 4 and 5, which are schematic diagrams of an application scenario and the progress of sound waves of the present embodiment, the inner muff member 1 wraps around a user's ear so as to form a tight sound space 24. The speaker element 6 has its axis aligned with the ear canal. As such, the speaker element 6 produces sound, the sound would directly reach the eardrum through the sound releasing element 21 and then the ear canal, thereby enhancing the sound quality and creating a superior sense of space as sound is reflected in the sound space 24 enclosed by the inner muff member 1 and the main member 2. More importantly, as sound reverberates in the sound space 24, a portion of the sound wave that progresses towards the openings 231 is damped by the tuning elements 5 on the openings 231 and maintained in the sound space 24.

After the rear cap 3 and the external muff member 4 are joined to the main member 2, a rear chamber is formed between the main member 2 and the external muff member 4. The sound space 24 and the rear chamber are isolated and the sound wave in the sound space 24 does not enter the rear chamber through the openings 231. The air pressures within the sound space 24 and the rear chamber are of appropriate proportion.

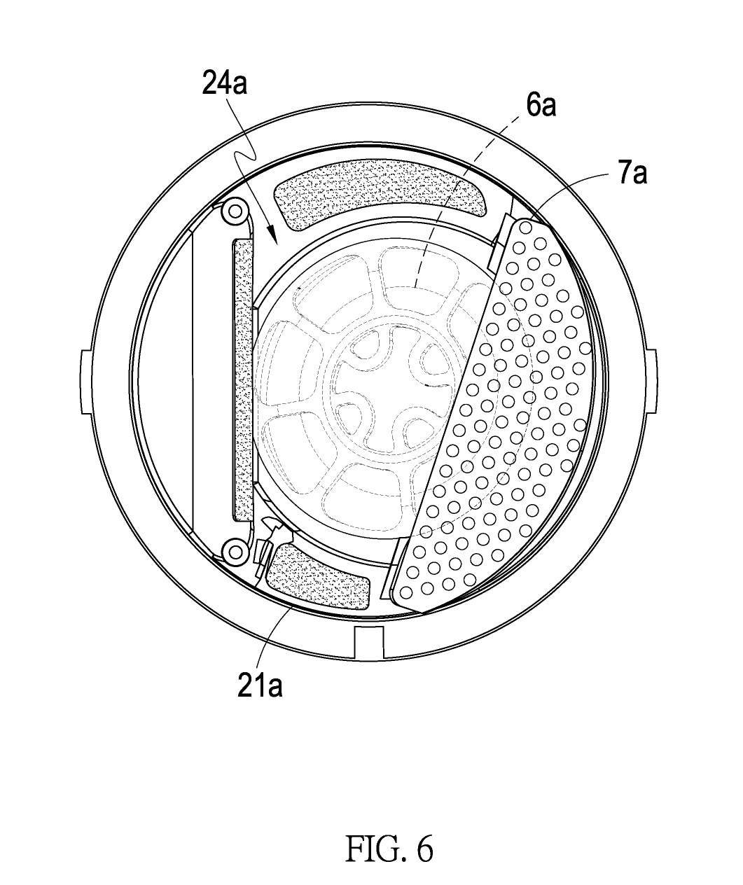

As shown in FIG. 6, an earpiece according to another embodiment of the present invention further includes a static electricity element 7a inside the sound space 24a and the speaker element 6a are alternately configured. The included angles between the speaker element 6a and the static electricity element 7a, and between the static electricity element 7a and the sound releasing element 21a are all between 0 and 20 degrees, achieving a superior surround sound effect is achieved.

Compared to the prior art, the present invention has the following advantages.

Firstly, through slant arrangement of the fixation element 22, the sound from the sound releasing element 6 on the fixation element 22 is able to directly reach the eardrum through the ear canal, thereby enhancing sound quality.

Secondly, through the tuning element 5 (e.g., turning paper), an appropriate proportion between the air pressures within the sound space 24 and the rear chamber is achieved. The sound wave would be reflected within the sound space 24, achieving superior surround effect.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A earpiece structure, comprising
a main member comprising a sound releasing element on an inner side, a fixation element besides the sound releasing element slant toward an outer side of the main member, and an extension element between the sound releasing element and the fixation element;
a plurality of through opening configured on the extension element;
a plurality of tuning elements, each configured on and covering one of the openings; and
a speaker element disposed on the fixation element.

2. The earpiece structure according to claim 1, further comprising a rear cap joined to an outer side of the main member.

3. The earpiece structure according to claim 2, further comprising an external muff member is joined to an outer side of the rear cap.

4. The earpiece structure according to claim 1, wherein an included angle between the sound releasing element and the fixation element is between 16 and 24 degrees.

5. The earpiece structure according to claim 1, wherein a sound space is formed between the sound releasing element and the fixation element.

6. The earpiece structure according to claim 5, further comprising a static electricity element inside the sound space.

7. The earpiece structure according to claim 6, wherein the static electricity element and the speaker element are alternately configured.

8. The earpiece structure according to claim 7, wherein included angles between the speaker element and the static electricity element, and between the static electricity element and the sound releasing element are all between 0 and 20 degrees.

9. The earpiece structure according to claim 1, further comprising an inner muff member housing the main member.

10. The earpiece structure according to claim 1, wherein each tuning element is a tuning paper.
